(19) United States
(12) Patent Application Publication
(10) Pub. No.: US 2010/0229648 A1
(43) Pub. Date: Sep. 16, 2010

(54) DEVICE CONTAINING A FLUID REFRACTING ULTRASOUND MODALITY

(75) Inventors: Jan Frederik Suijver, Dommelen (NL); Anna T. Fernandez, Croton-on-Hudson, NY (US); Christopher S. Hall, Hopewell Junction, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,170

(22) PCT Filed: Apr. 12, 2007
(86) PCT No.: PCT/IB07/51329

§ 371 Date: Feb. 20, 2009

Related U.S. Application Data
(60) Provisional application No. 60/823,282, filed on Aug. 23, 2006.

(51) Int. Cl. G01N 29/02

(52) U.S. Cl. 73/589

(57) ABSTRACT

An acoustic device is disclosed having a variably refracting acoustic fluid interface including the boundary between two separate fluid media, means for directing acoustic waves onto the interface, and an acoustic generator or transducer located in one of the fluid media with the acoustic generator having an impedance that is substantially equal to the one said fluid media to minimize signal loss and reflection.

The disclosure is directed to an acoustic device having a variably refracting acoustic fluid interface including the boundary between two separate fluid media, means for directing acoustic waves onto the interface, and an acoustic generator or transducer located in one of the fluid media to minimize signal loss and reflection.

Acoustic waves are useful in many scientific or technical fields, such as medical diagnosis, non-destructive control of mechanical parts and underwater imaging, etc. Acoustic waves allow diagnoses and controls which are complementary to optical observations, because acoustic waves can travel in media that are not transparent to electromagnetic waves.

PCT International Publication Number WO 2005/122139 A2 published on Dec. 22, 2005 discloses an acoustic device having a variable focus acoustic fluid lens and ultrasonic wave generator which is located in the bottom wall housing and external to the fluid lens. U.S. Pat. No. 5,240,005 granted Aug. 31, 1993 discloses an acoustic focusing device having a fluid lens for variably focusing ultrasonic and shock waves, and, an ultrasonic transducer that is integrated into the device structure by means of a holding arm.

However, the ultrasound emitted from the ultrasonic wave generator or transducer should be coupled into the patient with as little internal reflection thereby minimizing signal loss and the confounding effect of multiple return paths for the ultrasonic signal. In practice, this implies minimizing the losses induced by the lens.

These and other needs are satisfied with the acoustic device of the present disclosure.

According to the present disclosure, an acoustic device having a variably refracting (for example, focusing or deflecting) acoustic fluid interface including the boundary between two separate fluid media, means for directing acoustic waves onto the interface (for example, lens) and an acoustic generator or transducer located in one of the fluid media to minimize signal loss and reflection is disclosed.

Specifically, it is an object of the invention to provide an acoustic device that minimizes signal loss and reflection comprising an acoustic interface that is capable of variably refracting acoustic waves, means for directing acoustic waves onto the interface, and an acoustic generator, wherein the acoustic interface comprises:

two separate fluid media in which the acoustic waves have different speeds of sound;

a boundary between said media, and means for applying a force directly onto at least part of one of the fluid media so as to selectively induce a displacement of at least part of said boundary; and

the acoustic generator being located in one of the fluid media, the acoustic generator having an impedance that is substantially equal to the one said fluid media, the acoustic wave directing means being located between the generator and the acoustic interface, wherein an acoustic wave is produced by the generator and passes through the acoustic interface boundary and second fluid media towards an object located outside said device.

Another object is to provide an acoustic device comprising an acoustic interface that is capable of variably focusing acoustic waves.

Another object is to provide comprising an acoustic interface that is capable of variably deflecting acoustic waves.

Another object is to provide an acoustic device wherein the two fluid media have substantially equal densities.

Another object is to provide an acoustic device wherein the acoustic wave velocity in one of the fluid media is at least 5% different from that of the other fluid media.

Another object is to provide an acoustic device wherein the two fluid media are based on water and silicone oil, respectively.

Another object is to provide an acoustic device wherein the two fluid media are not miscible with each another, and wherein said boundary is a contact meniscus between the two fluid media.

Another object is to provide an acoustic device wherein said acoustic interface is a lens of Fresnel-type.

Another object is to provide an acoustic device wherein said boundary comprises an elastic film.

Another object is to provide an acoustic device further comprising another elastic film wherein the elastic films are arranged to hold one of the two fluid media at two respective locations of a path of the acoustic waves.

Another object is to provide an acoustic device wherein one of the two fluid media comprises a polar or electrically conductive liquid substance, the second of the two fluid media comprises a non-polar or electrically isolating liquid substance, and wherein the force applying means comprise an electrode arranged to apply an electric force onto at least part of said first fluid medium.

Another object is to provide an acoustic device wherein the electrode is arranged to apply the electric force on a part of said first fluid medium adjacent the boundary.

Another object is to provide an acoustic device wherein the force applying means comprise a movable body contacting said part of the fluid medium.

Another object is to provide an acoustic device wherein the movable body comprises a wall of a vessel containing said part of the fluid medium.

Another object is to provide an acoustic device wherein the acoustic interface operates in the ultrasonic wavelength range.

These and other aspects of the invention are explained in more detail with reference to the following embodiments and with reference to the figures.

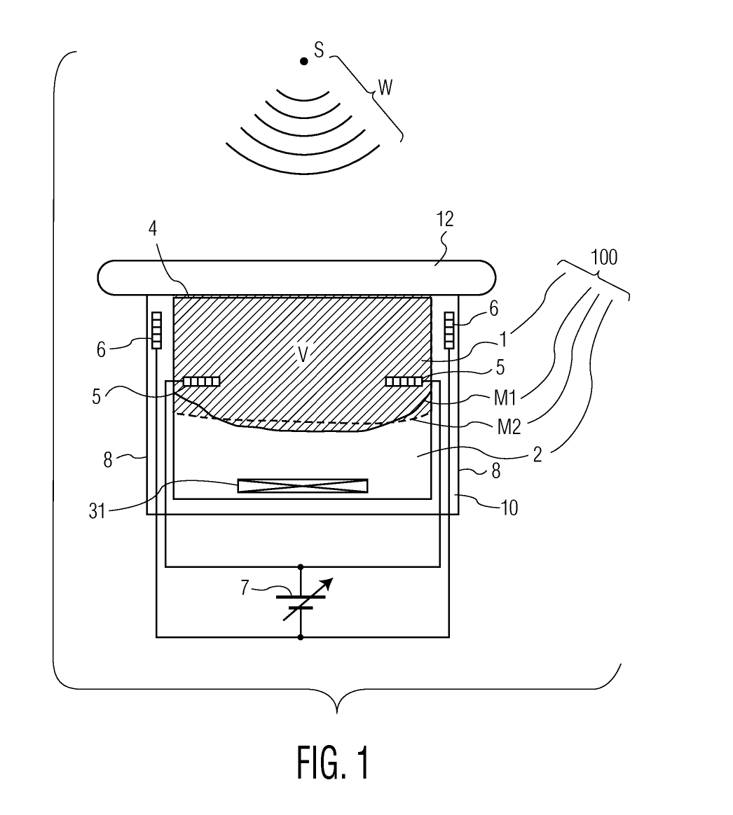

FIG. 1 is a schematic sectional view of an ultrasonic probe according to a first embodiment of the invention.

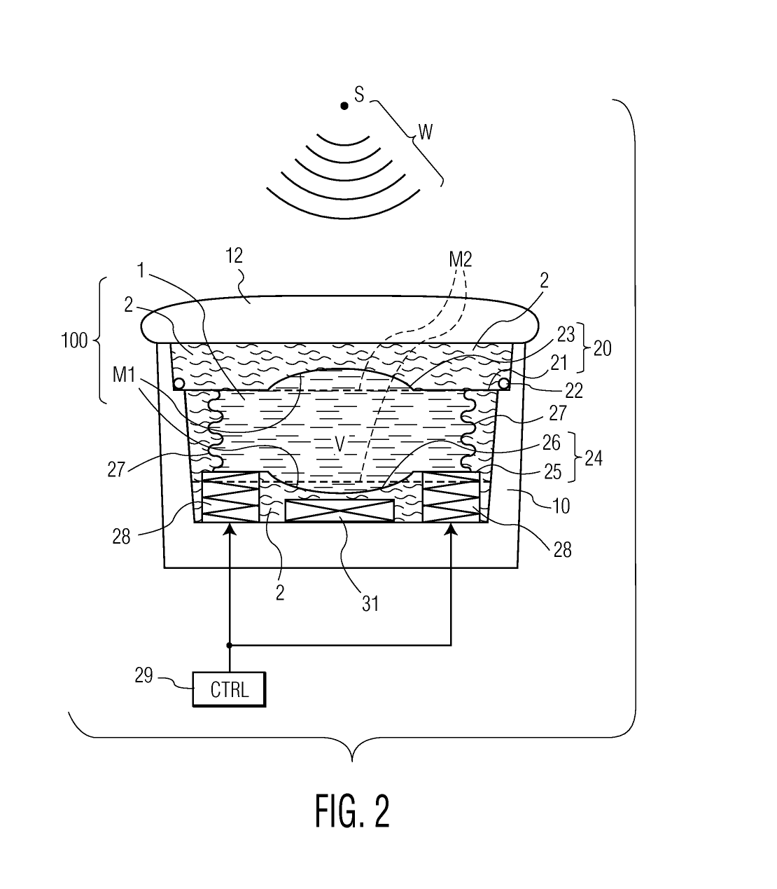

FIG. 2 is a schematic sectional view of an ultrasonic source according to a second embodiment of the invention.

FIGS. 1 and 2 are modifications of the FIGS. 1 and 2 in PCT International Publication Number WO 2005/122139 A2 published on Dec. 22, 2005, according to the disclosure herein. In these figures, same numbers refer to similar elements, or to elements with similar function. Furthermore, for clarity reason, the sizes of the represented elements do not correspond to sizes of real elements.

According to the invention herein disclosed, an acoustic device is provided that minimizes signal loss and reflection of acoustic waves. This is accomplished by suitably modifying the acoustic device disclosed in PCT International Publication Number WO 2005/122139 A2 published on Dec. 22, 2005, so that the ultrasonic transducer or generator is located in one of the fluid media of the acoustic interface, for example a lens, that is capable of variably refracting acoustic waves. Refracting of acoustic waves also includes, but is not limited to, focusing and deflecting of acoustic waves

Ideally, the device disclosed in Publication WO 2005/122139, which is herein incorporated by reference in its entirety, is modified by placing the transducer in one of the fluid media, for example, the oil-side of the acoustic interface, for example, a fluid variable focus lens. By a suitable choice of backing material, quarter-wavelength matching plate and other matching-layer coatings on the surface of the transducer, good acoustic impedance matching between the transducer and the oil can be obtained; in other words, the acoustic impedance of the acoustic generator or transducer is substantially equal to that of the fluid media (in the example, the oil) in which the generator is located. As the human body has an acoustic impedance that is close to that of water, this design has—by construction—low losses and low signal reflection when coupling the second fluid media, for example, the water-side of the device to a human body, ensuring efficient signal transmission through the fluid lens into the body. As the transducer is inside the liquid lens, the device can now be sealed completely with the exception of the upper wall: this should remain permeable for ultrasound, while remaining impermeable to the water layer in the lens. Naturally, electrical leads to drive the transducer and the fluid lens should come out of the device, but such contacts can be liquid-tight and need not be transparent for ultrasound. In order to allow ultrasound to pass through the upper wall, as will be required for functionality of the device, the upper wall should be transparent for correct transducer frequency range. This can be accomplished by suitable choice of a range of plastics with acoustic impedances close to that of water and human tissue.

Publication WO 2005/122139 discloses an acoustic device comprising an acoustic lens with variable focal length and means for directing incoming acoustic waves onto the lens. According to the invention, the acoustic lens comprises two fluid media in which the acoustic waves have different velocities, a boundary between said media, and means for applying a force directly onto at least part of one of the fluid media so as to selectively induce a displacement of at least part of said boundary. A displacement of at least part of said boundary includes any change in the position or in the shape of the boundary. As a consequence, the focal length of the acoustic interface or lens may be varied more rapidly.

Another advantage of a device according to the invention results from the shape of the boundary between the two fluid media of the acoustic interface or lens. Indeed, the shape of the boundary may be approximately a portion of a plane or a portion of a sphere. Then the imaging aberrations of the lens are well known, and can be corrected with additional fixed-focus aspheric acoustic lenses. Thus the focusing quality of the lens is very good.

Preferably, the two fluid media have substantially equal densities. Then, the displacement of the part of the boundary is independent on gravitation, and thus independent on the orientation of the acoustic device.

Advantageously, the fluid substances in the acoustic interface or lens may be selected so that the acoustic wave velocity in one of the fluid media is at least 5% different from that of the other fluid medium. Then, an important refractive effect occurs at the boundary between the two fluid media. The power of the acoustic lens, related to the focal length, may thus be adjusted to high values. This results in an important change of the vergence of the acoustic waves upon crossing the boundary. For example, the two fluid media may be based on water and silicone oil, respectively. The velocity of sound in water is about 1,490 m/s and the velocity of sound in silicone oil is about 790 m/s, i.e. 1.9 times lower.

As disclosed in the PCT publication and incorporated by reference herein, in a first embodiment of the invention, the two fluid media are not miscible with each another, and the boundary is a contact meniscus between the two fluid media. In this case, no wall is placed between both fluid media, resulting in a further reduction in the total mass of the mobile parts of the lens.

In a second embodiment of the invention, the boundary comprises an elastic film. Such film prevents both fluid media from mixing with each another, and it can be stretched by relatively small forces. The lens may also comprise another elastic film, the two elastic films being arranged to hold one of the two fluid media at two respective locations of a path of the acoustic waves. A higher power value of the lens can thus be achieved.

The means for applying the force directly onto at least part of one of the fluid media can be of several types. According to a first type, a first one of the two fluid media comprises a polar and/or electrically conductive liquid substance, and the force applying means comprise an electrode arranged to apply an electric force onto at least part of said first fluid medium. Such means are adapted for electronically controlling the displacement of the boundary. Rapid variations of the focal length of the acoustic lens can thus be obtained. The electric force is applied advantageously on a part of the first fluid medium which is adjacent the boundary. Then the whole quantity of first fluid medium may be reduced, allowing reductions in the mass and in the size of the device.

According to a second type, the force applying means comprise a movable body contacting said part of the fluid medium. In an optimized embodiment of this type, the movable body comprises a wall of a vessel containing said part of the fluid medium.

The device may be adapted so that the acoustic wave involved in the device is an ultrasonic wave. Then it can be used for any known application involving ultrasonic waves, for example high precision imaging or remote acoustic power delivery.

The device may be designed for imaging an object located outside said device. Then it further comprises an acoustic detector. The means for directing incoming acoustic waves onto the lens may comprise a coupling cushion arranged at an acoustic wave inlet of the device. The image is obtained when an acoustic wave travels from the object to the detector. The acoustic lens is arranged between the detector and the acoustic wave inlet of the device, so as to provide focusing onto a selected part of the object. Varying the focal length allows imaging of different parts of the object located at various distances in front of the imaging device. A more complete visualization of the object is thus possible. Furthermore, moving the imaging device is easier, because the imaging device is small-sized, more simple and less cumbersome than those already existing. Such acoustic imaging devices are useful for many applications, because they provide a non-destructive visualization method. They are useful for medical purposes or for material control, for example for checking whether a material body is free of cracks. Using of an acoustic wave of ultrasonic type further provides a higher resolution, due to the short wavelengths involved. The device may alternatively be designed for transmitting an acoustic wave towards an object located outside said device. Then, it further comprises an acoustic generator or transducer located in one of the fluids (for example, an oil-based fluid). The acoustic lens is arranged between the generator and an acoustic wave outlet of the device, so as to provide focusing of the transmitted acoustic wave onto a selected part of the object. The means for directing incoming acoustic waves onto the lens are located between the acoustic generator and the lens. These means may consist in a coupling fluid medium contacting both the generator and the lens, for example. Such device may be used, e.g. in lithotripsy applications.

The ultrasonic probe shown in FIG. 1 has a housing 10 made of electrically insulating material. The housing 10 has lateral walls 8 and may be of cylindrical shape, for example. It has an open top end and a closed bottom end. In an alternate embodiment the top end is closed by a fixed wall 4, which is transparent to acoustic waves. A film of polyethylene may form the wall 4 for example. An acoustic generator 31 is placed within the housing 10, close to the bottom end. The generator 31 is of a type well known in the art of acoustic waves. The output face of the generator 31 is oriented upwards, i.e. towards the top end of the housing 10.

A coupling cushion 12 is adapted to the top end of the housing 10 so as to define together with the housing 10 a sealed volume V between the bottom end of the housing 10 and the cushion 12. The volume V is for example about 3 cm in diameter, and about 1.5 cm in height, i.e. along the axis of the housing 10. The coupling cushion 12 is made up of a flexible sealed pocket filled with a liquid substance such as water. It is designed for developing a large contact area when pressed against a body, such as a human body.

The volume V is filled with two liquid media numbered 1 and 2 respectively. Liquid medium 1 preferably consists primarily of water. It is for example a salt solution, with ionic contents high enough to have an electrically polar behavior, or to be electrically conductive. Liquid medium 1 may contain potassium and chloride ions, both with concentrations of 1 mol per liter, for example. Alternatively, it may be a mixture of water and ethyl alcohol. Liquid medium 2 is for example made of silicone oil, that is insensitive to electric fields, non-polar or is electronically isolating.

Liquid media 1 and 2 are not miscible with each another. Thus they always remain as separate liquid phases in the volume V. The separation between the liquid media 1 and 2 is a contact surface or meniscus which defines a boundary without any solid part.

Within the volume V, preferably in the liquid 1, electrode 5 is located which may be in the form of a cylindrical ring have an opening in the center with an outer diameter approximately equal to the inner diameter of the housing 10. Electrode 5 may be electrically insulated from liquid medium 1. Then it is coupled capacitively with the liquid medium 1. In alternative embodiments, the electrode 5 may be in contact with the liquid medium 1.

In alternate embodiments, the wall 4 may be coated with a hydrophilic coating, so as to maintain the liquid medium 1 near the electrode 5. Thus the respective positions of the liquid media 1 and 2 remain unchanged when moving the probe, even upside down. Both liquids have substantially equal densities in order to make the interface between the liquid media 1 and 2 independent on gravitation and thus on the orientation of the probe.

The cushion 12, the liquid media 1 and 2, and the wall 4 form a guide for an acoustic wave W originating from the generator 31 traveling toward a point S located on the axis of the probe and outside housing 10 and distant from the cushion 12. The cushion 12 forms the outlet for the probe for the wave W, and the wave W travels out from the probe from the generator 31 toward the object S.

A second electrode 6 is located in the lateral wall 8 of the housing 10. Electrode 6 may have a cylindrical shape and surrounds the volume V. Electrode 6 is electrically insulated from electrode 5 and from liquid medium 1. Electrodes 5 and 6 are connected to two outputs of an adjustable voltage supply source 7.

When the voltage supplied by the source 7 is zero, then the contact surface between the liquid media 1 and 2 is a meniscus M1. In a known manner, the shape of the meniscus is determined by the surface properties of the inner side of the lateral wall of the housing 10; its shape is then approximately a portion of a sphere, especially for the case of equal densities of both liquid media 1 and 2. Because the acoustic wave W has different propagation velocities in the liquid media 1 and 2, the volume V filled with the liquid media 1 and 2 acts as a convergent lens 100 on the acoustic wave W. The convergence of the acoustic wave W leaving the probe is increased upon crossing the contact surface between the liquid media 1 and 2 and traveling to the object point S.

When the voltage supplied by the source 7 is set to a positive or negative value, then the shape of the meniscus is altered, due to the electrical field between the electrodes 5 and 6. In particular, a force is applied on the part of the liquid medium 1 adjacent the contact surface between the liquid media 1 and 2. Because of the polar behavior of liquid medium 1, it tends to move closer to the electrode 6, so that the contact surface between the liquid media 1 and 2 flattens. In the figure, M2 denotes the shape of the contact surface when the voltage is set to a non-zero value. Such electrically controlled change in the form of the contact surface is called electrowetting. In case liquid medium 1 is electrically conductive, the change in the shape of the contact surface between the liquid media 1 and 2 when voltage is applied is the same as previously described.

Because of the flattening of the contact surface, the focal length of the lens 100 is increased when the voltage is non-zero. For example, when the voltage supplied by the source 7 is set at about 100 volts, the focal length is about 20 cm.

The probe just described is advantageously combined with an ultrasonic generator located in the oil-based liquid portion of the lens within the same device. Therefore, the detected acoustic wave is a reflected part of an ultrasonic wave transmitted by the generator to an external body in contact with the cushion 12. In a known manner, a detection signal supplied by a detector used in conjunction with the device, allows identification of the type of the material located at the focus S, together with material properties such as sound velocity, density, hardness, speed of the liquid medium through Doppler effect, etc.

According to general imaging principles, the resolution of an imaging system is increased when increasing the size of the elements transmitting the waves. Therefore, the resolution of the previously described ultrasonic imaging device may be increased by using a lens with variable focal length having a larger diameter. But stability problems occur when the contact surface between the liquid media is too wide. A solution for increasing the diameter of the variable lens is to use a Fresnel-type lens. A Fresnel-type lens is divided into several parts, each part having the same refraction effect as a corresponding portion of an usual lens, but having a reduced thickness. Electrowetting may be used for controlling the shape of the contact surface between two liquid media in each part of the Fresnel-type lens. A Fresnel-type lens with a variable focal length is thus obtained.

Turning to FIG. 2, an ultrasonic source is now described. Reference 10 still refers to a housing with a closed lower end and an open upper end. The upper end is covered with a coupling cushion 12 similar to that previously described.

An ultrasonic generator 31 is located in the housing 10, within the oil-based fluid of the lens. V is the volume within housing 10 and below the cushion 12. The cushion 12 forms an outlet of the source for an ultrasonic wave W produced by the generator 31.

The volume V is divided with a fixed wall 20 into an upper part and a lower part. The wall 20 comprises a rigid disk 21 which is maintained against an inner shoulder of the housing 10 with a sealing ring 22 there between. The disk 21 has a circular opening in its central part, of about 4-5 cm in diameter. The opening is closed with a resilient film 23, for example a rubber film. In rest configuration, the film 23 is substantially planar. The upper part of the volume V between the cushion 12 and the wall 20 is filled with a liquid medium 2.

A movable wall 24 is arranged in the lower part of the volume V, between the fixed wall 20 and the generator 31. The wall 24 comprises a rigid disk 25. The disk 25 has a peripheral diameter smaller than the inner diameter of the housing 10, so that it can move up and down, i.e. along a direction parallel to the axis of the housing 10. The disk 25 has a circular opening in its central part, with a diameter approximately equal to the diameter of the opening of the disk 21. The opening of the disk 25 is closed with a film 26 which may be identical to the film 23. Peripheral bellows 27 connect both disks 21 and 25, so as to define a sealed vessel together with the walls 20 and 24 in the lower part of the volume V. Several actuators 28, for example four piezoelectric actuators, are arranged between the bottom end of the housing 10 and the disk 25. The actuators 28 are connected to a controller 29, so as to control the position of the mobile wall 24.

The vessel defined by the walls 20 and 24 together with the bellows 27 contains a liquid medium 1. Liquid medium 2 also fills the gap between the generator 31 and the movable wall 24 in order to direct onto the lens the acoustic waves output by the generator 31. The part of the liquid medium 2 located in this gap is hydrostatically coupled with the part of the liquid medium 2 located above the fixed wall 20. This coupling may be achieved by providing holes in the disk 21 outside the bellows 27 for example. Liquid media 1 and 2 are selected so that the ultrasonic waves have different propagation velocities in each liquid medium. As previously, liquid medium 1 may be based on water, while liquid medium 2 may be silicone oil.

When the movable wall 24 is in the rest position, i.e. in a lower position, both films 23 and 26 are planar (M2 in FIG. 2), so that the vergence of an ultrasonic wave W produced by the generator 31 is unchanged when traveling through the vessel containing liquid medium 1.

When the movable wall 24 is pushed upwards by the actuators 28, the volume filled with the liquid medium 1 remains constant because the liquid medium 1 is incompressible. The pressure in the liquid medium 1 becomes higher than the pressure in the liquid medium 2, so that both resilient films 23 and 26 are stretched outwards by the liquid medium 1. The respective shapes of the films 23 and 26 become spherical portions (M1 in FIG. 2). A lens 100 is thus obtained. The generator 31 produces a planar ultrasonic wave W. After having crossed the two films 23 and 26, the ultrasonic wave W is convergent, with a focus point S located outside the source, at a distance which depends on the curvatures of the films 23 and 26. Adjusting the position of the movable wall 24 with the controller 29 results in varying the curvatures of the films, and thus results in a variation in the focus length of the source.

Although the source has been described with two resilient films, it is clear that a single resilient film is sufficient for forming a lens with a variable focal length.

It is also possible to combine lens effects respectively obtained with boundaries between two liquid media as formed in the first and the second embodiments described above. Many other modifications may be implemented, without departing from the concept of acting directly onto at least one of the liquid media for varying the shape of the boundary. Additionally, light modality can be integrated with the ultrasonic modality in the device disclosed herein.

Another option is to combine a system with a direct contact surface between two liquid media as in the first embodiment with a movable part contacting at least one of the two liquid media. The contact with the movable part may also be combined with electrodes arranged as in the second embodiment.

While the present invention has been described with respect to specific embodiments thereof, it will be recognized by those of ordinary skill in the art that many modifications, enhancements, and/or changes can be achieved without departing from the spirit and scope of the invention. Therefore, it is manifestly intended that the invention be limited only by the scope of the claims and equivalents thereof.

1. Acoustic device that minimizes signal loss and reflection comprising an acoustic interface that is capable of variably refracting acoustic waves (100), means (12; 2) for directing acoustic waves onto the interface, and an acoustic generator (31), wherein the acoustic interface (100) comprises:
two separate fluid media (1, 2) in which the acoustic waves have different speeds of sound;
a boundary between said media, and means (5, 6, 7; 28, 29) for applying a force directly onto at least part of one of the fluid media (1) so as to selectively induce a displacement of at least part of said boundary; and
the acoustic generator (31) being located in one of the fluid media (2), the acoustic generator having an impedance that is substantially equal to the one said fluid media (2), the acoustic wave directing means (2) being located between the generator and the acoustic interface, wherein an acoustic wave (W) is produced by the generator and passes through the acoustic interface boundary and second fluid media (1) towards an object (S) located outside said device.

2. An acoustic device according to claim 1 comprising an acoustic interface that is capable of variably focusing acoustic waves.

3. An acoustic device according to claim 1 comprising an acoustic interface that is capable of variably deflecting acoustic waves.

4. Acoustic device according to claim 1, wherein the two fluid media (1, 2) have substantially equal densities.

5. Acoustic device according to claim 1, wherein the acoustic wave velocity in one of the fluid media (1) is at least 5% different from that in the other fluid media (2).

6. Acoustic device according to claim 1, wherein the two fluid media (1, 2) are not miscible with each another, and wherein said boundary is a contact meniscus (M1, M2) between the two fluid media.

7. Acoustic device according to claim 1, wherein the two fluid media (1, 2) are based on water and silicone oil, respectively.

8. Acoustic device according to claim 6, wherein said acoustic interface (100) is a lens of Fresnel-type.

9. Acoustic device according to claim 1, wherein said boundary comprises an elastic film (23).

10. Acoustic device according to claim 9, further comprising another elastic film (26), wherein the elastic films are arranged to hold one of the two fluid media (1) at two respective locations of a path of the acoustic waves (W).

11. Acoustic device according to claim 1, wherein one of the two fluid media comprises a polar or electrically conductive liquid substance, the second of the two fluid media comprises a non-polar or electrically isolating liquid substance, and wherein the force applying means comprise an electrode (5, 6) arranged to apply an electric force onto at least part of said first fluid medium.

12. Acoustic device according to claim 11, wherein the electrode (5, 6) is arranged to apply the electric force on a part of said first fluid medium (1) adjacent the boundary.

13. Acoustic device according to claim 1, wherein the force applying means comprise a movable body (24) contacting said part of the fluid medium (1).

14. Acoustic device according to claim 13, wherein the movable body (24) comprises a wall of a vessel containing said part of the fluid medium (1).

15. Acoustic device according to claim 1, wherein the acoustic interface operates in the ultrasonic wavelength range.
